(19) United States
(12) Patent Application Publication
(10) Pub. No.: US 2001/0047613 A1
(43) Pub. Date: Dec. 6, 2001

(54) Trap for murines

(76) Inventor: Mario Caffagni, Albareto (IT)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/844,576

(22) Filed: Apr. 27, 2001

(30) Foreign Application Priority Data
May 23, 2000 (IT) M02000A000108

(51) Int. Cl. A01M 23/34

(52) U.S. Cl. 43/85

(57) ABSTRACT

A trap for murines comprises a box-like body for containing captured murines and baits which is provided with at least one one-way inlet which is arranged in an upper region of a wall of the box-like body and is controlled by a vertically movable partition which is operated by a trapdoor means accommodated inside the box-like body.

### BACKGROUND OF THE INVENTION

The present invention relates to a trap for murines.

Traps for capturing mice particularly have long been known and used and have several shapes and mechanisms adapted to achieve the purpose in the best possible manner while retaining low source manufacturing costs so as to be able to offer commercially products which are competitive as to costs and operation.

The prior art traps, though operating substantially satisfactorily and having relatively low costs, can however be improved as regards structural versatility, since for example it is not possible to have traps which are operational simultaneously for multiple captures and can be combined in a modular manner so as to constitute a multifunctional unit, as mentioned.

### SUMMARY OF THE INVENTION

The aim of the present invention is to solve the above-noted drawbacks of the conventional traps by providing a trap for murines having a modular and simple structure and therefore significantly low costs, yet offering defect-free and particularly effective performance.

This aim and other objects which will become better apparent hereinafter are achieved by a trap for murines, comprising a box-like body for containing captured murines and baits, characterized in that said box-like body is provided with at least one one-way inlet which is arranged in an upper region of a wall of the box-like body and is controlled by a vertically movable partition being operated by a trapdoor means accommodated inside said box-like body.

### BRIEF DESCRIPTION OF THE DRAWINGS

Further characteristics and advantages of the present invention will become better apparent from the description of a preferred embodiment of a trap for murines, illustrated only by way of non-limitative example in the accompanying drawings, wherein:

FIG. 1 is a schematic sectional view, taken along a vertical plane, of a first embodiment of the trap according to the invention;

FIG. 2 is another schematic sectional view, taken along the same vertical plane as FIG. 1, of a trap for murines in a second embodiment;

FIG. 3 is a corresponding partial schematic sectional view thereof, taken along a horizontal plane.

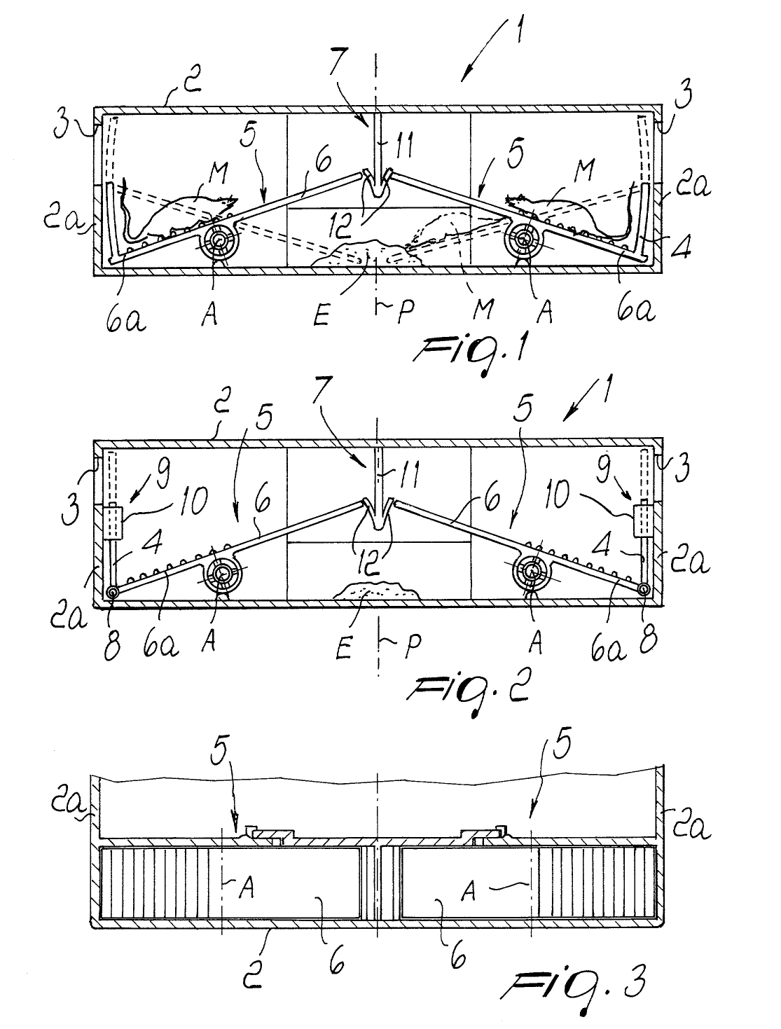

### DESCRIPTION OF THE PREFERRED EMBODIMENTS

With reference to the figures, the reference numeral 1 designates a trap for murines M, which comprises a box-like body 2 for containing the captured murines M and baits for facilitating their capture.

The box-like body 2 is provided with at least one one-way inlet 3 for the murines M which is formed in an upper region of a vertical wall 2a of the box-like body and is controlled by a partition 4 movable vertically and actuated by a trapdoor means 5 being accommodated inside the box-like body 2.

In a preferred embodiment of the trap according to the invention, the box-like body 2 is duplicated mirror-symmetrically with respect to a vertical median plane of symmetry P, so as to have at least two inlets 3 and a corresponding number of trapdoor means 5.

Each one of the trapdoor means 5 is constituted by a ramp 6 which is mounted in a rocker-like fashion inside the box-like body 2 and oscillates about a horizontal axis A; in a first embodiment of the trap 1, one end 6a of the ramp, which is directed towards the corresponding inlet 3, is associated rigidly with the corresponding partition 4, while the opposite end can be coupled to a transverse diaphragm means 7 for closing the region where the captured murines M are gathered.

In this embodiment of the invention, the partition 4 has a vertical cross-section shaped like a circular arc which is convex towards the corresponding inlet 3.

In a second embodiment of the invention, the partition 4 is articulated to the base in a hinge-like fashion about a horizontal axis 8 at the corresponding end 6a of the rocker-like ramp 6 and can move up and down with it in contact with the vertical wall 2a, guided by way of corresponding means 9 being constituted by at least one pair of lugs 10 having a C-shaped cross-section which protrude from the internal face of the wall 2a and arranged bilaterally to the partition 4, between which it is contained with minimal play.

The transverse diaphragm means 7 is constituted by a segment of a wall 11 which protrudes vertically from the top of the box-like body 2 and extends downward over part of the total useful height of the box-like body; the lower edge of the wall 11 is provided with lips 12 which can be mated by contact with the edge 6b of the ramp 6 that lies opposite the edge 6a provided with the partition 4.

Both rocker-like ramps 6 are articulated to the box-like body 2 asymmetrically about their oscillation axis, so that the portion directed towards the wall 11 is shorter than the portion directed towards the respective inlets 3.

The shorter portions of the ramps 6 are further provided with counterweights, not shown, thereby increasing their own weight.

The operation of the trap according to the invention is self-evident and is as follows: when a rodent M enters through one of the inlets 3, it falls immediately onto the underlying ramp 6 and, by continuing along the ramp towards the inside of the box-like body 2 to reach the bait arranged therein, it turns the ramp 6 about the axis A.

In this way, the partition 4 blocks the corresponding inlet 3: if the partition is rigidly coupled to the end 6a of the ramp 6, the curvature allows to reach the fully closed but not hermetic configuration without interfering with the wall 2a; if the partition 4 is articulated to the end 6a of the ramp 6, the rotation of the ramp pushes upward the partition 4, which is guided in its sliding between the bilateral lugs 10, achieving also in this case the configuration for closing the inlet 3.

When the murine M climbs off the ramp 6, the ramp, due to its own weight, turns again, lowering the partition 4 and thus allowing access to the trap 1 again.

Inside the trap, the deposited bait E prepared with poisonous substances kills the captured murines M, which are subsequently removed by opening the top of the box-like body 2.

In practice it has been found that the described invention achieves the intended aim and objects.

The invention thus conceived is susceptible of numerous modifications and variations, all of which are within the scope of the appended claims.

All the details may further be replaced with other technically equivalent ones.

In practice, the materials used, as well as the shapes and the dimensions, may be any according to requirements without thereby abandoning the scope of the protection of the appended claims.

The disclosures in Italian Patent Application No. MO2000A000108 from which this application claims priority are incorporated herein by reference.

What is claimed is:

1. A trap for murines, comprising a box-like body for containing captured murines and baits, wherein said box-like body is provided with at least one one-way inlet which is arranged in an upper region of a wall of the box-like body and is controlled by a vertically movable partition which is operated by a trapdoor means accommodated inside said box-like body.

2. The trap according to claim 1, wherein said box-like body is duplicated mirror-symmetrically with respect to a vertical median plane of symmetry of the box-like body.

3. The trap according to claim 1, wherein said trapdoor means is constituted by at least one ramp which is mounted in a rocker-like manner in said box-like body, one end of said ramp, directed to said inlet, being associated with said partition, an opposite end being couplable with a transverse diaphragm means for closing a region of the box-like body where captured murines are gathered.

4. The trap according to claim 3, wherein said partition is rigidly coupled to said end of said rocker-like ramp.

5. The trap according to claim 4, wherein said partition has a vertical cross-section which is shaped like a circular arc which is convex towards the corresponding inlet.

6. The trap according to claim 3, wherein said partition is articulated in a hinge-like fashion, about a horizontal axis, to said corresponding end of the rocker-like ramp, and is movable up and down with said ramp in contact with said wall of the box-like body, guided by way of corresponding guiding means.

7. The trap according to claim 6, wherein said guiding means are constituted by at least one pair of lugs having a C-shaped cross-section which protrude from an internal face of said wall of the box-like body provided with said inlet, said lugs being arranged bilaterally to said partition, which is contained between them within minimal play.

8. The trap according to claim 3, wherein said transverse diaphragm means is constituted by a segment of a wall which protrudes vertically from the top of said box-like body and extends downward over part of an overall useful height of the box-like body, a lower edge of said wall of the box-like body being provided with lips which can be mated by contact with an edge of said ramp that lies opposite an edge provided with said partition.

9. The trap according to claim 3, wherein said rocker-like ramp is articulated to said box-like body asymmetrically with respect to an oscillation axis thereof, a portion of the ramp directed towards said wall of the box-like body being shorter than a portion directed towards said inlet.

10. The trap according to claim 9, wherein said portions of the ramp directed towards the inlet is provided with counterweights which add to the weight of the ramp.
